(19) United States
(12) Patent Application Publication
(10) Pub. No.: US 2008/0317086 A1
(43) Pub. Date: Dec. 25, 2008

(54) Self-calibrating digital thermal sensors

(76) Inventors: Ishmael F. Santos, Milpitas, CA (US); James G. Hermerding, San Jose, CA (US)

Correspondence Address: CAVEN & AGHEVLI;c/o INTELLEVATE, LLC, P.O. BOX 52050, MINNEAPOLIS, MN, 55402, US

(21) Appl. No.: 11/821,366

(22) Filed: Jun. 22, 2007

(51) Int. Cl. G01K 15/00

(52) U.S. Cl. 374/1

(57) ABSTRACT

Methods and apparatus relating to calibration of digital thermal sensors after manufacturing are described. In one embodiment, a temperature value sensed by a digital thermal sensor may be calibrated based on a temperature value sensed by a thermal diode. The thermal diode and the digital thermal sensor may be on the same integrated circuit chip. Other embodiments are also disclosed.

### BACKGROUND

The present disclosure generally relates to the field of electronics. More particularly, an embodiment of the invention relates to self-calibrating digital thermal sensors.

Some current integrated circuit (IC) chips may utilize a digital thermal sensor (DTS) to detect the temperature of electronic components proximate to the DTS. Accurate internal DTSs are becoming increasingly more important for on-chip thermal management. For example, temperature may be ramped to a calibration point via an external heating method. DTS fuses may then be blown at that temperature. Heating chips externally may however require time to heat and can be relatively inaccurate (e.g., +/−5 to 10 degrees C.). Accordingly, current DTS calibration techniques can be costly, time-consuming, and inaccurate.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 4 illustrate block diagrams of embodiments of computing systems, which may be utilized to implement some embodiments discussed herein.

FIG. 2 illustrates a block diagram of a self-calibrating digital thermal sensor system, according to an embodiment of the invention.

FIG. 3 illustrates a block diagram of an embodiment of a method to self-calibrate a digital thermal sensor.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

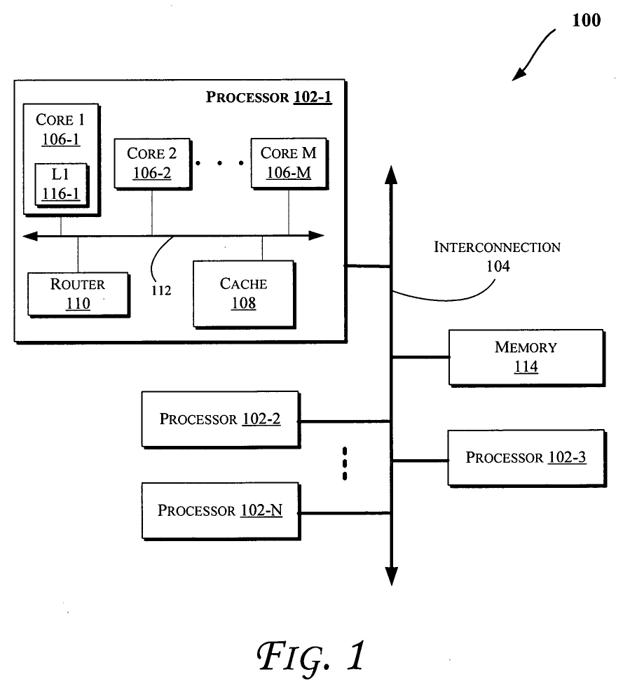

Some of the embodiments discussed herein may enable self-calibration of a digital thermal sensor (DTS) after the manufacturing process, e.g., during run-time. In an embodiment, the self-calibration may be performed in accordance with a value derived from an internal thermal diode (TD), which may be relatively more easily and/or accurately calibrated. The techniques discussed here and may be applied in various computing systems, such as those discussed with reference to FIGS. 1-4. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

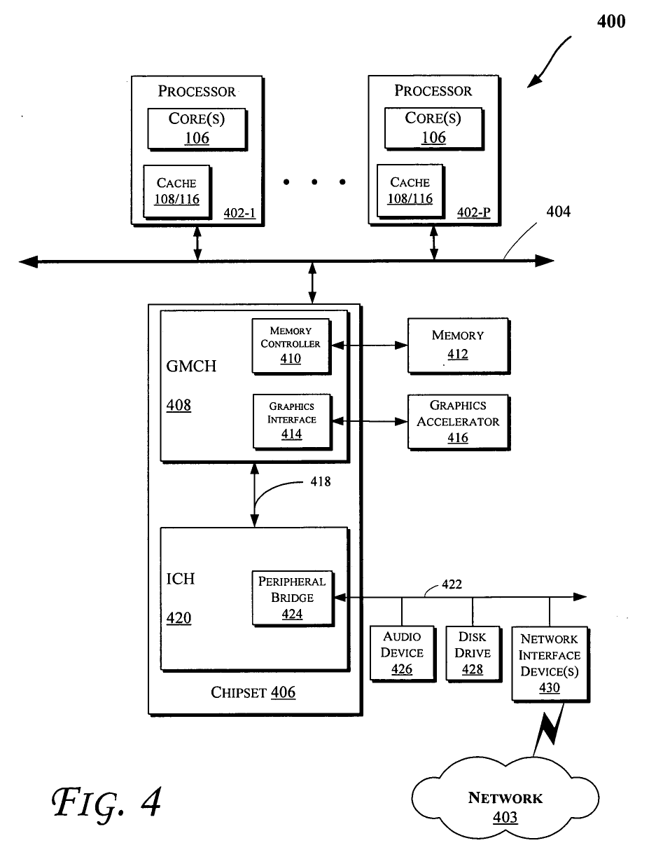

In an embodiment, the processor 102-1 may include one or more processor cores 106-1 through 106-M (referred to herein as “cores 106,” or “core 106”), a cache 108, and/or a router 110. The processor cores 106 may be implemented on a single integrated circuit (IC) chip. Moreover, the chip may include one or more shared and/or private caches (such as cache 108), buses or interconnections (such as a bus or interconnection 112), memory controllers (such as those discussed with reference to FIG. 4), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102 (e.g., faster access by cores 106). As shown in FIG. 1, the memory 114 may communicate with the processors 102 via the interconnection 104. In an embodiment, the cache 108 (that may be shared) may be a mid-level cache (MLC), a last level cache (LLC), etc. Also, each of the cores 106 may include a level 1 (L1) cache (116-1) (generally referred to herein as “L1 cache 116”) or other levels of cache such as a level 2 (L2) cache. Moreover, various components of the processor 102-1 may communicate with the cache 108 directly, through a bus (e.g., the bus 112), and/or a memory controller or hub.

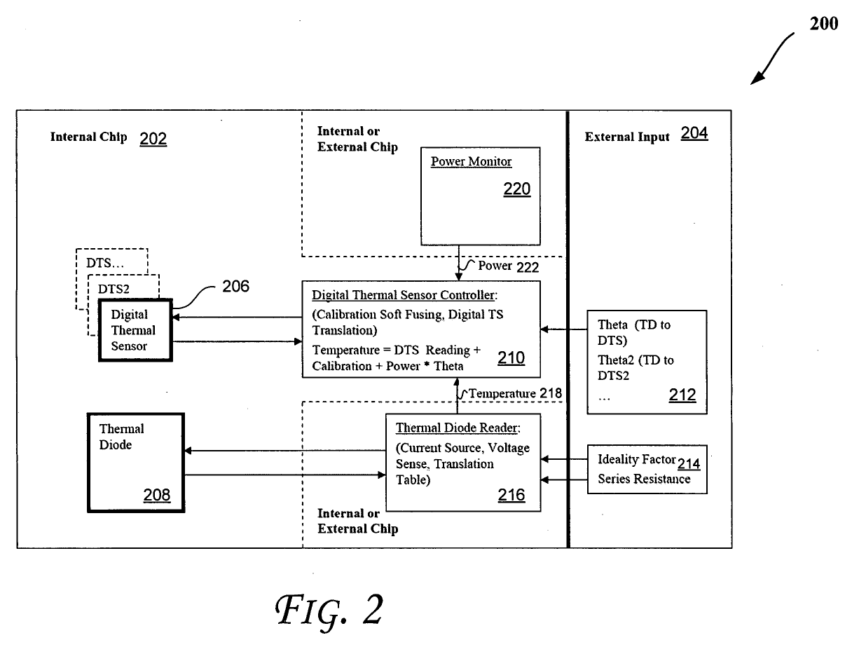

FIG. 2 illustrates a block diagram of a self-calibrating digital thermal sensor system 200, according to an embodiment of the invention. In an embodiment, each of the components discussed with reference to FIGS. 1 and/or 4 may include one or more components of the system 200.

As shown in FIG. 2, the system 200 may include an IC chip 202 which may in one embodiment receive external inputs 204. The chip 202 may be any type of an IC chip such as the components discussed with reference to FIGS. 1 and/or 4. The chip 202 may include one or more: digital thermal sensor(s) 206 (which may be collectively referred to herein as “DTS” or “digital thermal sensor” 206)), at least one thermal diode (TD) 208, and/or a digital thermal sensor controller 210. External inputs 204 may include one or more theta values (e.g., which may correspond to the temperature delta in degrees C. per change in power in Watts) for TD to DTS conversions 212 (e.g., indicating an offset that may be used to map TD and DTS values, which may be determined before manufacturing via thermal simulation and values are check post-Silicon or pre-high volume manufacturing for accuracy, in an embodiment), an ideality factor, and/or series resistance (the later two items 214 corresponding to the TD 208 in accordance with one embodiment, and collectively referred to hereinafter as “TD inputs”). Generally, the ideality factor refers to a parameter in the thermal diode current-voltage relationship relating to maximum deviation on a particular diode to an ideal diode (for example an increase in ideality factor may create error in temperature measurement if not compensated for) and the series resistance value compensates for error due to series resistance in thermal diode temperature measurement.

In one embodiment, the TD 208 may be coupled to a thermal diode reader logic 216 (which may be on or off the IC chip 202) which receives the TD inputs 214. The thermal diode reader logic 216 may generate a signal 218 (which may indicate the value of temperature sensed by the TD 208), for example, based on the value of the TD inputs 214, TD current source, TD voltage sense, and/or stored values in a translation table. Also, a power monitor logic 220 (which may be on or off the IC chip 202) may generate a power signal 222 (which may indicate a power value that is used by controller 210 to determine a DTS to TD offset power value, e.g., such as illustrated in FIG. 2 and derived based on a corresponding theta value 212, in an embodiment). In an embodiment, the signal 222 may correspond to the power consumption level of the IC chip 202.

As shown in FIG. 2, the signals 218 and 222 may be provided to the digital thermal sensor controller 210 to cause the digital thermal sensor controller 212 to calibrate temperature values sensed by one or more of the digital thermal sensors 206 (e.g., via software-based fusing or switching (for example stored as values in a register in an embodiment) and/or digital thermal sensor (TS) translation). In one embodiment, the DTS reading may be adjusted (or modified) by a calibration value (as discussed above) and/or a product of a power value and a corresponding theta value 212 (e.g., provided by the power monitor 220) to generate a calibrated temperature value.

Furthermore, in one embodiment, the digital thermal sensors 206 (and corresponding logic which may control thermal management in the IC 202) may be provided on the same die but their temperature accuracy may need to be calibrated after manufacturing, e.g., at run-time. As previously mentioned, temperature calibration during manufacturing can however be costly, time-consuming, and inaccurate. Sensing temperature values by a TD (e.g., TD 208) may be relatively more accurate, require little calibration, and/or be programmed after manufacturing sort and test. In one embodiment, TD 208 may need an external, off-die device, to be read and may not directly control internal chip thermal management. Furthermore, TD may be less dependant on process variation than DTS but might be much larger than DTS and may need special on-die routing requirements. Therefore, a TD may not be readily placed at chip hotspots in an embodiment. Digital thermal sensors may be more readily placed at chip hotspots in some embodiments. Accordingly, one embodiment calibrates sensed temperature values of a DTS based on temperature values sensed by a TD (e.g., which may be in relatively close proximity to the DTS or at least on the same chip as the DTS being calibrated).

Moreover, in an embodiment, the TD sensed temperature values may be fed back to DTS logic (e.g., controller 210) for self-calibration of the digital thermal sensors 206. TD ideality factor and series resistance 214 may be fed into TD reading mechanism (e.g., thermal diode reader logic 216) for a relatively more accurate temperature feedback. The internal calibration processes discussed herein may utilize a filter for temperature correction. For example, in systems with a TD in a thermally different (e.g., relatively far) location from DTS (which may create a large thermal gradient), chip power feedback (e.g., provided by power monitor logic 220) may be used to calculate thermal gradient (e.g., a value based on the product of a power value and a corresponding theta of a select DTS 206). Accordingly, in one embodiment DTS self-calibration may be performed at runtime. Also, in some embodiments, DTS self-calibrations may be performed at specific times (e.g., when the widest temperature range may exist) for a more robust temperature calibration.

Additionally, in some embodiments, e.g., in systems with DTS and externally read TD, temperature may be read back to DTS controller 210 for self-calibration via an external input (e.g., as theta values 212). In an embodiment, in systems with DTS and self reading of TD values, temperature may be read back to DTS controller internally for self-calibration (e.g., via signal 218). In one embodiment, when TD is relatively far from DTS (e.g., in different thermal zones such as in a processor), the thermal gradient may be accounted for with an internal power monitor input (e.g., based on the signal 222 from the power monitor logic 220). In some embodiments, e.g., when TD is relatively close to DTS (e.g., within the same or close thermal zones such as in smaller chips including, for example, a graphics memory control hub (GMCH) or an input/output control hub (ICH) chips), thermal gradient correction (e.g., based on signal 222) may not be performed.

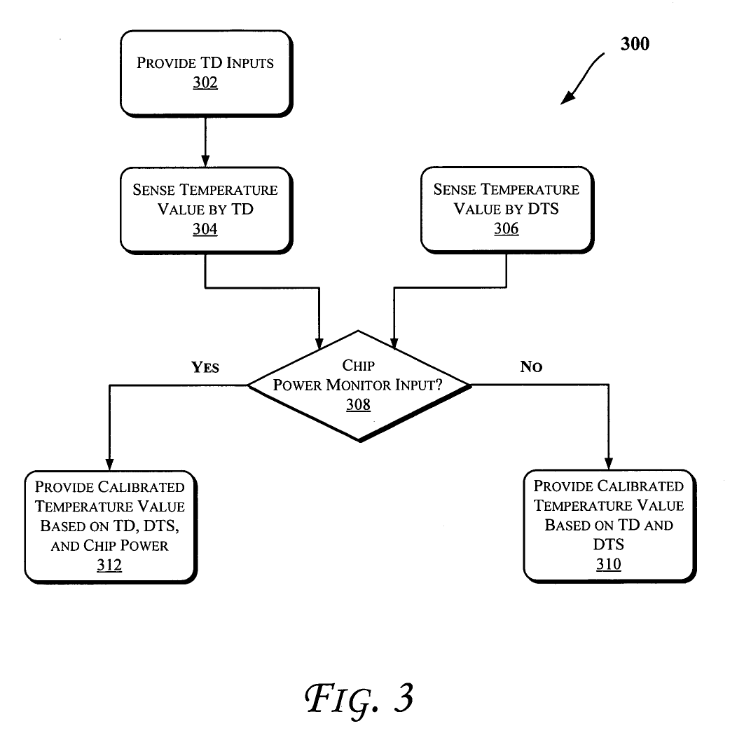

FIG. 3 illustrates a block diagram of an embodiment of a method 300 to self-calibrate a digital thermal sensor. In an embodiment, various components discussed with reference to FIGS. 1-2 and 4 may be utilized to perform one or more of the operations discussed with reference to FIG. 3. For example, the method 300 may be used to calibrate temperature values sensed by the digital thermal sensor(s) 206.

Referring to FIGS. 1-4, at an operation 302, TD input values are provided (e.g., TD inputs 214 are provided to the TD reader 216). At an operation 304, TD may sense a temperature value (which may be provided to the TD reader 216 as discussed with reference to FIG. 2). At an operation 306 (which may be performed prior to, after, or substantially simultaneously as operation 304), a DTS (e.g., one of the digital thermal sensors 206) may sense a temperature value. At an operation 308, it may be determined whether a chip power monitor input is present or should be taken into account (e.g., based on the signal 222 as further discussed herein). If the chip power monitor input is not to be taken into account, at an operation 310, the sensed DTS temperature value may be calibrated (such as discussed herein, e.g., with reference to FIG. 2). Otherwise, at an operation 312, the sensed DTS temperature value may be calibrated based on TD sensor input and chip power monitor input (such as discussed herein, e.g., with reference to FIG. 2).

In one embodiment, the following pseudo-code summarizes some of the operations for calibrating DTS-sensed temperature values:

Delta Temperature=DT=DTS Temperature−TD Temperature [1]

Calibration=filter(DT) [2]

Example Filter:

Constant*DT(n−1)+(1−Constant)*DT(n), [3]

Sample Rate=1 to 10 samples/seconds, Constant<1 [4]

Temperature=DTS Reading+Calibration+(Power*Theta) [5]

FIG. 4 illustrates a block diagram of a computing system 400 in accordance with an embodiment of the invention. The computing system 400 may include one or more central processing unit(s) (CPUs) or processors 402-1 through 402-P (which may be referred to herein as “processors 402” or “processor 402”). The processors 402 may communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, one or more of the processors 402 may be the same or similar to the processors 102 of FIG. 1. In some embodiments, one or more of the processors 402 may include one or more of the cores 106, cache 108, and/or cache 116 of FIG. 1. Also, the operations discussed with reference to FIGS. 1-3 may be performed by one or more components of the system 400.

A chipset 406 may also communicate with the interconnection network 404. The chipset 406 may include a graphics memory control hub (GMCH) 408. The GMCH 408 may include a memory controller 410 that communicates with a memory 412 (which may be the same or similar to the memory 114 of FIG. 1). The memory 412 may store data, including sequences of instructions that are executed by the processor 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The GMCH 408 may also include a graphics interface 414 that communicates with a graphics accelerator 416. In one embodiment of the invention, the graphics interface 414 may communicate with the graphics accelerator 416 via an accelerated graphics port (AGP). In an embodiment of the invention, a display (such as a flat panel display, a cathode ray tube (CRT), a projection screen, etc.) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 418 may allow the GMCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the processor 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and one or more network interface device(s) 430 (which is in communication with the computer network 403). Other devices may communicate via the bus 422. Also, various components (such as the network interface device 430) may communicate with the GMCH 408 in some embodiments of the invention. In addition, the processor 402 and the GMCH 408 may be combined to form a single chip. Furthermore, the graphics accelerator 416 may be included within the GMCH 408 in other embodiments of the invention.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 400 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-4, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a digital thermal sensor to sense a first temperature value;
a thermal diode to sense a second temperature value; and
a digital thermal sensor logic to calibrate the first temperature value based on the second temperature value.

2. The apparatus of claim 1, further comprising a thermal diode reader coupled to the thermal diode to receive a sensed temperature value from the thermal diode and generate a signal corresponding to the second temperature value.

3. The apparatus of claim 2, wherein one or more of the digital thermal sensor, the thermal diode, the digital thermal sensor logic, or thermal diode reader are on a same integrated circuit chip.

4. The apparatus of claim 1, further comprising a power monitor logic to generate a signal corresponding to a power consumption level of an integrated circuit chip that causes the digital thermal sensor logic to calibrate the first temperature value based on: the second temperature value and the signal.

5. The apparatus of claim 4, wherein the integrated circuit chip comprises one or more of the digital thermal sensor, the thermal diode, the digital thermal sensor logic, thermal diode reader, or the power monitor logic.

6. The apparatus of claim 1, wherein one or more of the digital thermal sensor, the thermal diode, or the digital thermal sensor logic are on a same integrated circuit chip.

7. The apparatus of claim 6, wherein the integrated circuit chip comprises one or more of: a processor, a graphics memory control hub, or an input/output control hub.

8. The apparatus of claim 7, wherein the processor comprises one or more processor cores.

9. The apparatus of claim 1, further comprising a plurality of digital thermal sensors to sense a first plurality of temperature values, wherein the digital thermal sensor logic is to calibrate the first plurality of sensed temperature values based on the second temperature value.

10. A method comprising:
sensing a first temperature value by a digital thermal sensor;
sensing a second temperature value by a thermal diode; and
adjusting the first temperature value based on the second temperature value.

11. The method of claim 10, further comprising generating a signal corresponding to a power consumption level of an integrated circuit chip, wherein the adjusting the first temperature value is performed based on: the second temperature value and the signal.

12. The method of claim 11, wherein one or more of the digital thermal sensor, the thermal diode, or the digital thermal sensor logic are on the integrated circuit chip.

13. The method of claim 10, further comprising generating a signal corresponding to the second temperature value based on one or more of an ideality factor of the thermal diode or a series resistance of the thermal diode.

14. The method of claim 10, further comprising:
sensing a first plurality of temperature values by a plurality of digital thermal sensors; and
calibrating the first plurality of sensed temperature values based on the second temperature value.

15. The method of claim 10, wherein the adjusting is performed based on a theta value for thermal diode to digital thermal sensor conversion.
